(19) United States
(12) Patent Application Publication
(10) Pub. No.: US 2017/0262829 A1
(43) Pub. Date: Sep. 14, 2017

(54) Financial Transaction Medium

(71) Applicant: Hewlett-Packard Development Company, L.P., Houston, TX (US)

(72) Inventors: Napoleon J Leoni, Palo Alto, CA (US); Omer Gila, Palo Alto, CA (US); Henryk Birecki, Palo Alto, CA (US)

(21) Appl. No.: 15/500,002

(22) PCT Filed: Jul. 29, 2014
(86) PCT No.: PCT/US2014/048627

§ 371 Date: Jan. 27, 2017

(51) Int. Cl. G06Q 20/20; G06Q 20/38; G07F 7/08; G06Q 20/34

(52) U.S. Cl. CPC G06Q 20/206; G06Q 20/34; G06Q 20/385; G07F 7/0846; G06F 21/36

(57) ABSTRACT

One example of a financial transaction medium includes a passive electronic paper display. A security code is displayed on a portion of the passive electronic paper display.

### BACKGROUND

Electronic paper (“e-paper”) is a display technology designed to recreate the appearance of ink on ordinary paper. Some examples of e-paper reflect light like ordinary paper and may be capable of displaying text and images. Some e-paper is implemented as a flexible, thin sheet, like paper. One familiar e-paper implementation includes e-readers.

### BRIEF DESCRIPTION OF THE DRAWINGS

FIG. 1 illustrates one example of an imaging system.

FIG. 2 illustrates one example of a financial transaction medium.

FIG. 3 illustrates another example of a financial transaction medium.

FIG. 4 illustrates another example of a financial transaction medium.

FIG. 5 illustrates a cross-sectional view of one example of an electronic paper (“e-paper”) display.

FIG. 6 illustrates one example of an imaging device.

FIG. 7 is a flow diagram illustrating one example of a method for writing to a financial transaction medium.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Electronic paper (“e-paper”) is used in a variety of display applications such as signage, e-books, tablets, cards, posters, and pricing labels. E-paper has several paper-like features. For example, e-paper is a reflective display that uses ambient light as an illumination source. The ambient light strikes the surface and is reflected to the viewer. The usage of pigments similar to those that are used in printing allows the e-paper to be read at a wide range of angles and lighting conditions, including full sunlight. The use of ambient light also eliminates the need for illumination produced by the device, such as a backlight. This minimizes the power used by the e-paper. In addition, the e-paper does not use power to maintain the image. Once the image is written, the image remains on the e-paper for an extended period of time or until the e-paper is rewritten. Thus, a typical e-paper primarily uses power for changing the optical state of the e-paper.

E-paper is typically written by generating a charge on a surface in proximity to a layer of microcapsules that contain charged pigment particles. The charge on the surface attracts or repels the charged pigment particles in the microcapsules to create the desired image. No physical supplies (e.g., ink) are used for writing to e-paper and the power used to write to e-paper is low.

Fraud is a costly problem throughout the world. A large portion of customer and consumer related fraud is related to financial transaction media (e.g., payment cards), such as gift cards, prepaid cards, debit cards, and credit cards. Due to fraud related to financial transaction media, retailers and credit card companies use several static methods to add an extra layer of security to financial transactions using payment cards. Credit Card companies utilize a security code, such as a Card Code Verification (CCV) code, which is a three or four digit code printed on the credit card separately from the credit card number. The security code is typically not recorded in transactions, but rather provided upon request when performing transactions by phone or online for example. Since the security code is visible and static, there is still the possibility that the security code may be overlooked and/or copied, thus lowering the protection of the user against fraud.

Another example of a security code is the Personal Identification Number (PIN) provided on gift cards. Retailers often provide the PIN under a scratchable layer so that the security code is not revealed until a consumer buys the gift card. If the security code is scratched before the gift card is purchased, the gift card may be compromised and should not be sold. The PIN is typically used to enable consumers to perform purchases online using the gift card. If a consumer uses a gift card after the security code is revealed, there is a chance that the security code may be copied by a third party, thus enabling fraudulent use of the gift card.

The following disclosure describes examples of display devices, such as financial transaction media, that provide a new level of security unattainable through the existing methods at a similar price point. Accordingly, a financial transaction medium, such as a gift card, prepaid card, debit card, or credit card, includes a passive e-paper display. The passive e-paper display is imageable by receiving charges on an imaging surface of the e-paper display from an imaging device. The imaging device is communicatively coupled to a secure server for processing financial transactions using information obtained from the financial transaction media.

The e-paper display of a financial transaction medium includes a portion displaying a security code. The security code is updated by an imaging device after receiving an updated security code from a secure server. The secure server provides an updated security code to the imaging device for writing to the e-paper display each time the financial transaction medium is accessed by an imaging device. The security code may be a dynamic CCV code, a dynamic PIN, or other suitable code, and may be embedded in an image, such as a Quick Response (QR) code. By updating the security code each time the financial transaction medium is accessed by an imaging device, the security of the financial transaction medium is improved, thereby reducing fraud. It is noted that if the financial transaction medium is used for an online purchase or other purchase where a suitable imaging device is not available, the security code is not updated until the next time the financial transaction medium is used to perform a transaction via an imaging device.

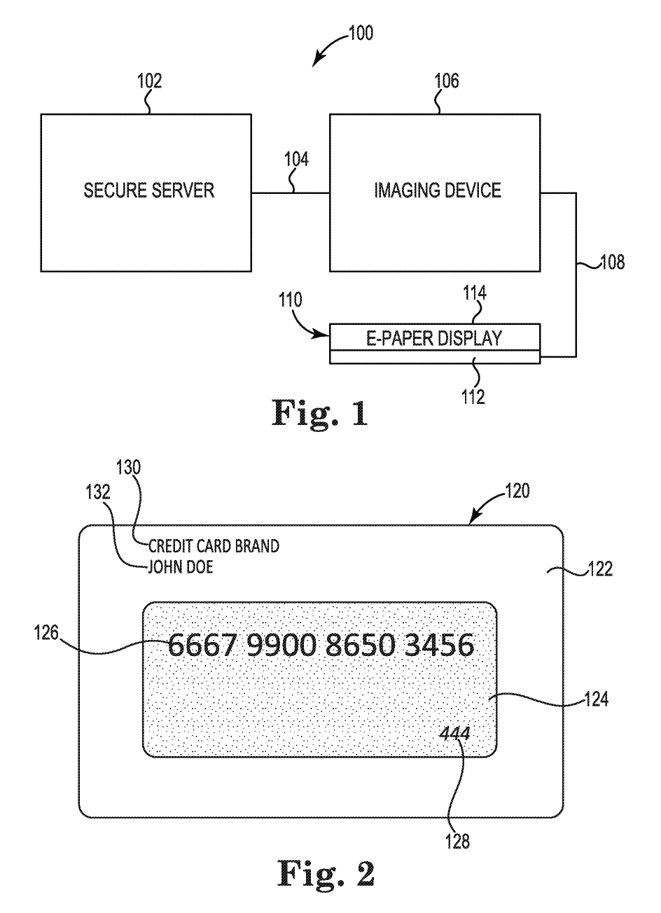

FIG. 1 illustrates one example of an imaging system 100. Imaging system 100 includes a secure server 102, an imaging device 106, and an e-paper display device 110. In one example, e-paper display device 110 is a financial transaction medium, such as a gift card, prepaid card, debit card, or credit card. Secure server 102 is communicatively coupled to imaging device 106 through a communication link 104. In one example, communication link 104 is a Local Area Network (LAN) communication link, a Wide Area Network (WAN) communication link, an Internet communication link, or another suitable communication link.

Secure server 102 processes financial transactions using information obtained from financial transaction media accessed through imaging device 106. Secure server 102 processes gift card transactions, prepaid card transactions, debit card transactions, credit card transactions, or other suitable payment card transactions. Secure server 102 communicates with imaging device 106 to provide instructions and data to the imaging device for erasing and writing to e-paper display device 110 and for completing transactions.

Imaging device 106 receives the instructions and data from secure server 102 and erases and/or writes to e-paper display device 110 and/or completes transactions in response to the instructions and data. In one example, imaging device 106 is incorporated into a payment card charging unit (e.g., credit card charging unit), an Automated Teller Machine (ATM), a retailer point of sale device, or another suitable device suitable for performing transactions using financial transaction media. Prior to and during erasing or writing to e-paper display device 110, imaging device 106 is electrically coupled to e-paper display device 110 through a ground connection 108. Once e-paper display device 110 has been erased and/or written, ground connection 108 may be removed.

E-paper display device 110 includes an active layer that switches color when an electric field or electrical charges is/are applied to an imaging surface 114 of e-paper display device 110. In one example, the active layer contains a switchable pigment or dye combination. A resin or polymer may be used to encapsulate the active layer. E-paper display device 110 includes a ground return path including a ground electrode 112, which provides a counter-electrode for the imaging of e-paper display device 110 by imaging device 106. Ground electrode 112 and ground connection 108 allow counter charges to flow to ground electrode 112 from imaging device 106. Thus, e-paper display device 110 remains basically charge neutral despite charges being ejected onto imaging surface 114. Without a connection between ground electrode 112 and imaging device 106, no appreciable amount of charges can be ejected onto imaging surface 114 and thus no information can be written to e-paper display device 110. One example of e-paper used in e-paper display device 110 is further described below with reference to FIG. 5.

To process a transaction, imaging device 106 receives a payment card identifier (e.g., account number, ISO/IEC 7812 number, numeric identifier, alphanumeric identifier, or other suitable identifier) and a security code (e.g., CCV code, PIN, numeric code, alphanumeric code, or other suitable code) linked to the payment card identifier from a financial transaction medium. The payment card identifier and/or security code are received via a magnetic stripe reader, bar code reader, QR code reader, smart chip reader, Near Field Communication (NFC) interface, image sensor, keypad (i.e., manual entry), or other suitable input device or combination thereof for reading information printed, displayed, stored, or encoded on the financial transaction medium. Secure server 102 receives the payment card identifier and the security code linked to the payment card identifier from imaging device 106.

Secure server 102 verifies that the received payment card identifier and security code are valid. If the received payment card identifier and security code are valid, secure server 102 processes the transaction. If the received payment card identifier and/or security code is invalid, secure server 102 denies the transaction. In one example, if the secure server 102 denies the transaction, imaging device 106 writes a message to e-paper display device 110 indicating that the transaction was denied. The message indicating that the transaction was denied may include instructions for the consumer on how to reactivate the financial transaction medium.

After processing a transaction through imaging device 106, secure server 102 provides an updated security code linked to the payment card identifier to imaging device 106 for writing to e-paper display device 110. Imaging device 106 receives the updated security code from secure server 102 and updates the security code written to e-paper display device 110. In this way, fraud can be reduced by preventing an unauthorized user from repeatedly using an illegally obtained payment card identifier and/or security code to make purchases since the security code is updated each time the financial transaction medium is accessed by an imaging device by the authorized user.

FIG. 2 illustrates one example of a financial transaction medium 120. In this example, financial transaction medium 120 is a credit card. Financial transaction medium 120 may be used in imaging system 100 previously described and illustrated with reference to FIG. 1. Financial transaction medium 120 includes a support structure 122 and an e-paper display 124. E-paper display 124 is mounted in support structure 122. One example of e-paper display 124 is further described below with reference to FIG. 5. Financial transaction medium 120 may also include a magnetic stripe, smart chip, bar code, QR code, or other suitable component for storing or encoding a payment card identifier and/or other suitable data for using financial transaction medium 120 for transactions.

Support structure 122 can be composed of a transparent material or an opaque material. Support structure 122 can be composed of polyester, plastic, glass, transparent Mylar, or other suitable material. In one example, support structure 122 includes a bottom layer and a top layer with e-paper display 124 arranged between the bottom layer and the top layer. In this example, support structure 122 is shaped to provide a financial transaction medium 120 in the form of a credit card.

Financial transaction medium 120 may include permanently marked portions on the support structure 122 as indicated for example at 130 and 132. The permanently marked portions may be printed with ink, laser marked, embossed, or marked using another suitable technique. The permanently marked portions may include card branding 130, the card owner's name 132, or other suitable text and/or images, such as bar codes or QR codes.

A portion of e-paper display 124 of financial transaction medium 120 includes a dynamic security code 128 that can be updated by an imaging device. In this example, security code 128 is a CCV code. Security code 128 is updated each time financial transaction medium 120 is accessed by an imaging device to complete a transaction as previously described with reference to FIG. 1. Another portion of e-paper display 124 includes a payment card identifier 126 (e.g., account number, ISO/IEC 7812 number, numeric identifier, alphanumeric identifier, or other suitable identifier). In this example, the payment card identifier is a 16 digit credit card number. The payment card identifier can be permanently written to the e-paper display, or like the security code, can be dynamic and updated via an imaging device each time financial transaction medium 120 is accessed by an imaging device. In other examples, e-paper display 124 may include other text and/or images.

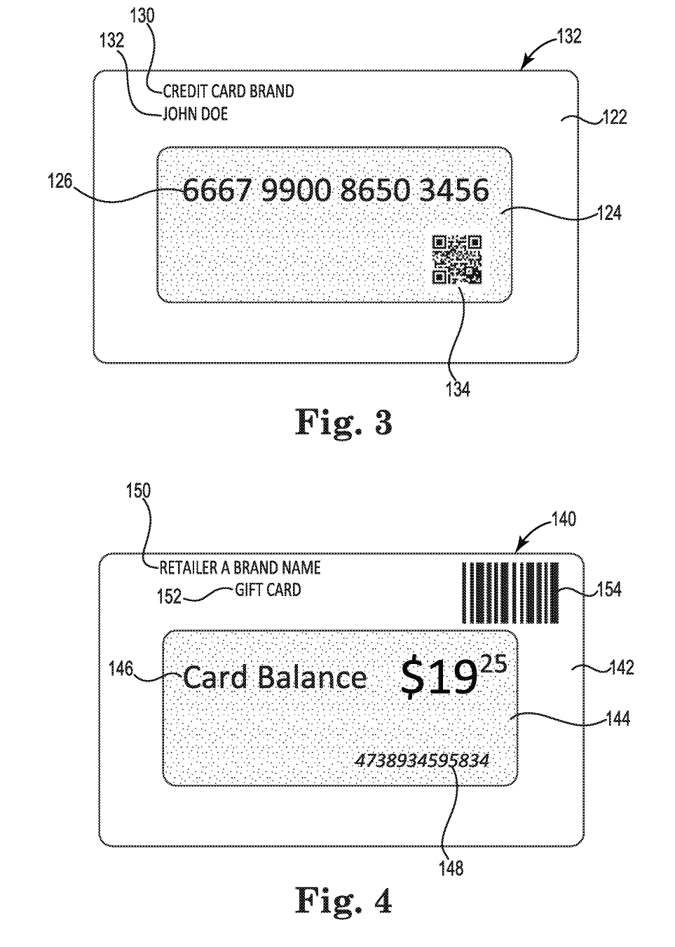

FIG. 3 illustrates another example of a financial transaction medium 132. Financial transaction medium 132 is similar to financial transaction medium 120 previously described and illustrated with reference to FIG. 2, except that financial transaction medium 132 embeds the security code in an image 134 written to e-paper display 124. In this example, image 134 is a QR code. In other examples, image 134 can be a bar code or other suitable image having an embedded security code. Security code 134 is updated each time financial transaction medium 132 is accessed by an imaging device as previously described with reference to FIG. 1.

FIG. 4 illustrates another example of a financial transaction medium 140. In this example, financial transaction medium 140 is a gift card. Financial transaction medium 140 may be used in imaging system 100 previously described and illustrated with reference to FIG. 1. Financial transaction medium 140 includes a support structure 142 and an e-paper display 144. E-paper display 144 is mounted in support structure 142. One example of e-paper display 144 is further described below with reference to FIG. 5. Financial transaction medium 140 may also include a magnetic stripe, smart chip, bar code, QR code, or other suitable component for storing or encoding a payment card identifier and/or other suitable data for using financial transaction medium 140 for transactions.

Financial transaction medium 140 may include permanently marked portions on the support structure 142 as indicated for example at 150, 152, and 154. The permanently marked portions may be printed with ink, laser marked, embossed, or marked using another suitable technique. The permanently marked portions may include card branding 150, a card identifier 152, a bar code 154, and/or other suitable text and/or images. In one example, bar code 154 provides a payment card identifier that uniquely identifies financial transaction medium 140 or provides other suitable information.

A portion of e-paper display 144 of financial transaction medium 140 includes a dynamic security code 148 that can be updated by an imaging device. In this example, security code 148 is a PIN. Security code 148 may be left blank until a consumer purchases financial transaction medium 140. At the point of purchase of financial transaction medium 140, security code 148 is written to e-paper display 144 by an imaging device. In this way, financial transaction medium 140 cannot be compromised prior to purchase, thus reducing fraud. Security code 148 is then updated each time financial transaction medium 140 is accessed by an imaging device to complete a transaction as previously described with reference to FIG. 1.

Another portion of e-paper display 144 includes a card balance as indicated at 146. In one example, card balance 146 may be left blank until a consumer purchases financial transaction medium 140. At the point of purchase of financial transaction medium 140, card balance 146 is written to e-paper display 144 by an imaging device. Card balance 146 is then updated each time financial transaction medium 140 is accessed by an imaging device to complete a transaction. In other examples, e-paper display 144 may include other text and/or images.

FIG. 5 illustrates a cross-sectional view of one example of an e-paper display 200. In one example, e-paper display 200 is used in e-paper display device 110 previously described and illustrated with reference to FIG. 1, e-paper display 124 previously described and illustrated with reference to FIGS. 2 and 3, and e-paper display 144 previously described and illustrated with reference to FIG. 4. E-paper display 200 includes a ground electrode 202, an active layer 204, and a transparent charge receiving layer 206. Active layer 204 includes microcapsules 208 encapsulated by a resin or polymer 214. In one example, each microcapsule 208 includes black particles 210 and white particles 212 suspended in a fluid medium 216. Surface 207 of charge receiving layer 206 provides the imaging surface for e-paper display 200 and is also the viewing side for a viewer 218 in this example. In other examples, ground electrode 202 may be transparent and provide the viewing side.

Ambient light is transmitted through charge receiving layer 206, strikes microcapsules 208, and is reflected back to the viewer 218. When white particles 212 of a microcapsule 208 are located near charge receiving layer 206, the microcapsule appears white to a viewer 218. When black particles 210 of a microcapsule 208 are located near charge receiving layer 206, the microcapsule appears black to the viewer 218. The particles 210 and 212 have opposite charges. For example, black particles 210 can be positively charged particles, and white particles 212 can be negatively charged particles. Various shades of gray can be created by varying the arrangement of alternating microcapsules with white and black particles located near charge receiving layer 206 to produce halftoning. Microcapsules 208 exhibit image stability using chemical adhesion between particles and/or between the particles and the microcapsule surface. For example, microcapsules 208 can hold text and images indefinitely without using electricity, while allowing the text or images to be changed later.

The structure, materials, and dimensions of the various layers and components of e-paper display 200 can be adapted to specific design criteria. In one example, the transparent charge receiving layer 206 can be composed of a transparent polymer and can have a thickness between 50 μm and 250 μm. The transparent charge receiving layer 206 can also be composed of a material that holds charges or is porous or semi-porous to charges and/or ions.

The diameter of each microcapsule 208 is substantially constant within e-paper display 200 and can be in one example between 20 μm and 100 μm, such as 50 μm. Conductive ground electrode 202 can be composed of a transparent conductive material, such as indium tin oxide, or an opaque material. In one example, ground electrode 202 has a thickness between 10 nm and 1 mm, or larger depending on how e-paper display 200 is to be used.

In other examples, e-paper display 200 has a variety of other configurations. For example, each microcapsule 208 may include black particles suspended in a white colored fluid. The black particles can be positively charged particles or negatively charged particles. One or more microcapsules form a pixel of black and white images displayed on e-paper display 200. The black and white images are created by placing black particles near or away from charge receiving layer 206. For example, the microcapsules with black particles located away from charge receiving layer 206 reflect white light, corresponding to a white portion of an image displayed on e-paper display 200. In contrast, the microcapsules with black particles located near charge receiving layer 206 appear black to a viewer 218 corresponding to a black portion of the image displayed on e-paper display 200. Various shades of gray can be created by using halftoning with black particles located near or away from charge receiving layer 206.

Charge receiving layer 206 may be tinted with alternating blue, red, and green regions. Adjacent blue, red, and green regions form color pixels. Color images are created by placing different combinations of white or black particles near charge receiving layer 206. For example, the microcapsules of a color pixel with white particles located near the red and green regions of charge receiving layer 206 reflect red and green light from e-paper display 200. The viewer 218 will perceive this combination as a yellow pixel. When the black particles in the microcapsules are located near charge receiving layer 206, that color pixel will appear black to the viewer 218. Additionally or alternatively, the black particles 210 of each microcapsule can be replaced by blue, red, or green positively or negatively charged particles. The particles can be used alone or in combination with a tinted charge receiving layer 206 to create a desired color image.

In another example, an alternative configuration for an e-paper display may be used in which the viewing side for a viewer 218 is located on the side of ground electrode 202. For this example, charge receiving layer 206 does not need to be transparent and the properties of charge receiving layer 206 are optimized to receive charges and transport the charges to the microcapsules.

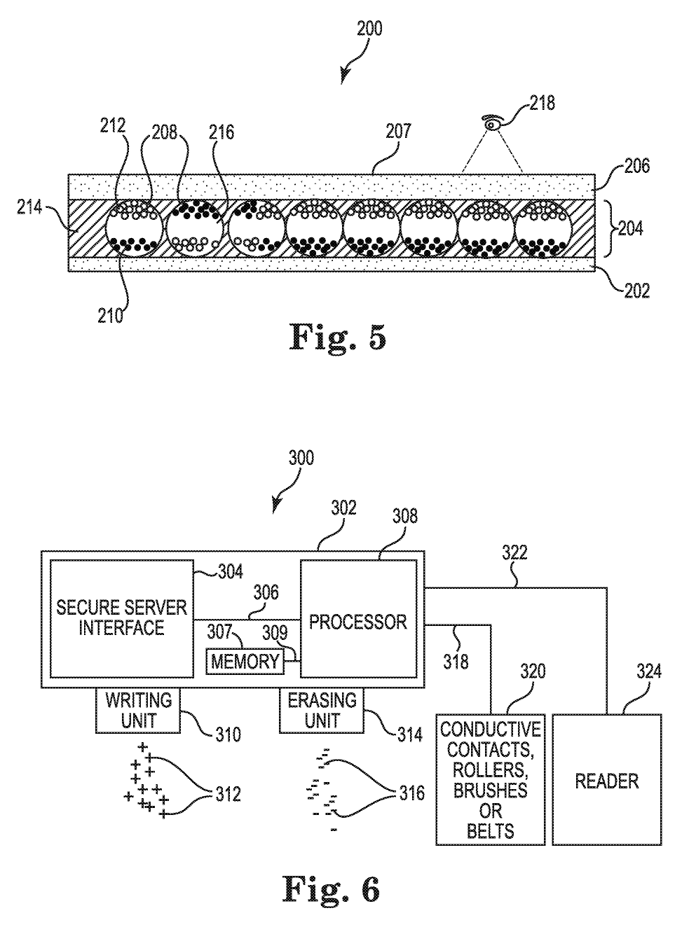

FIG. 6 illustrates one example of an imaging device 300. In one example, imaging device 300 provides imaging device 106 previously described and illustrated with reference to FIG. 1. Imaging device 300 is used to read information from and write information to financial transaction medium 120, 132, and/or 140 previously described and illustrated with reference to FIGS. 2-4. Imaging device 300 includes an imaging unit 302, conductive contacts, rollers, brushes, or belts 320, and a reader 324. Conductive contacts, rollers, brushes, or belts 320 are electrically coupled to imaging unit 302 through signal path 318. Reader 324 is communicatively coupled to imaging unit 302 through communication link 322. Imaging unit 302 includes a secure server interface 304, a processor 308, a memory 307, a corona writing unit 310, and a corona erasing unit 314.

Secure server interface 304 is for communicatively coupling imaging device 300 to a secure server, such as secure server 102 previously described and illustrated with reference to FIG. 1. Secure server interface 304 is communicatively coupled to processor 308 through a communication link 306. Processor 308 is communicatively coupled to memory 307 through a communication link 309. Processor 308 includes a Central Processing Unit (CPU) or another suitable processor. In one example, memory 307 stores instructions executed by processor 308 for operating imaging device 300. Memory 307 includes any suitable combination of volatile and/or non-volatile memory, such as combinations of Random Access Memory (RAM), Read-Only Memory (ROM), flash memory, and/or other suitable memory. In one example, processor 308 executes instructions to control imaging device 300 for accessing a financial transaction medium including reading information from the financial transaction medium via reader 324 and erasing and/or writing to an e-paper display of the financial transaction medium.

Corona writing unit 310 and corona erasing unit 314 are located on the same side of imaging unit 302. In one example, corona writing unit 310 and corona erasing unit 314 each include an addressable non-contact ion head. Corona erasing unit 314 selectivity ejects negative ions 316 toward an imaging surface of an e-paper display to erase any text and/or images on the e-paper display by repelling the negatively charged particles and/or by attracting the positively charged particles within the e-paper display toward the imaging surface. Corona writing unit 310 selectively ejects positive ions 312 toward an imaging surface of an e-paper display to write desired text and/or images on the e-paper display by repelling the positively charged particles and/or by attracting the negatively charged particles within the e-paper display toward the imaging surface.

Conductive contacts, rollers, brushes, or belts 320 make contact with the ground connection of the e-paper display of a financial transaction medium during erasing and/or writing of the e-paper display to provide an electrical connection to the ground electrode (e.g., ground electrode 202 previously described and illustrated with reference to FIG. 5) of the e-paper display. When using conductive rollers or belts, the rollers or belts can also set the spacing between corona writing unit 310 and corona erasing unit 314 and the e-paper display during writing of the e-paper display. The conductive rollers or belts are composed of any suitable electrically conductive material, such as a metal or conductive rubber. When using a conductive brush, the brush is composed of any suitable electrically conductive material, such as a metal or carbon.

Reader 324 accesses a financial transaction medium for performing transactions. Reader 324 includes a magnetic stripe reader, bar code reader, QR code reader, smart chip reader, NFC interface, image sensor, or other suitable input device for reading information, such as a payment card identifier and/or a security code, from a financial transaction medium. In one example, reader 324 reads the payment card identifier and/or security code from the e-paper display of a financial transaction medium.

While FIGS. 5 and 6 illustrate an example of a passive e-paper display and an imaging device for use with the passive e-paper display, in other examples, alternative physical implementations of a passive e-paper display may be used in financial transaction medium 120, 132, and/or 140 previously described and illustrated with reference to FIGS. 2-4. One example of an alternative physical implementation is based on a leuko-dye phase transition mechanism written and erased using thermal print technology similar to that used in point of sale terminals for receipt printing.

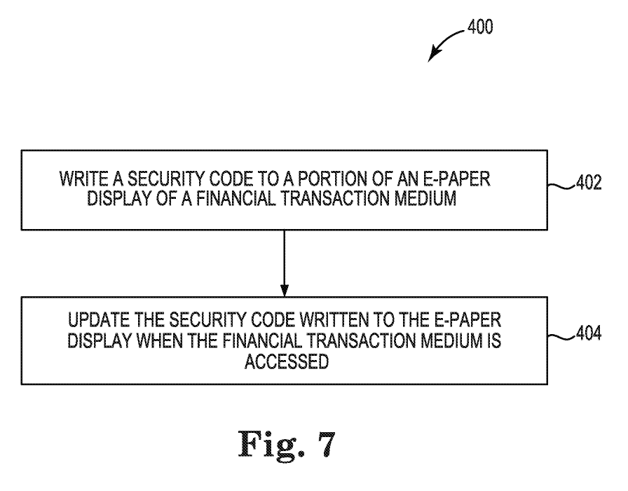

FIG. 7 is a flow diagram illustrating one example of a method 400 for writing to an e-paper display of a financial transaction medium, such as financial transaction medium 120, 132, or 140 previously described and illustrated with reference to FIGS. 2-4. At 402, a security code is written to a portion of an e-paper display of a financial transaction medium. The security code may be a CCV code, PIN, or other suitable code. At 404, the security code written to the e-paper display is updated when the financial transaction medium is accessed. The security code may be updated after the security code is used to perform a transaction. In one example, the security code is updated each time the financial transaction medium is accessed by an imaging device. In one example, the security code may be updated at a retail point of sale, such as a credit card charging unit. The security code may also be updated at an ATM machine or at another suitable point where the financial transaction medium is used with an imaging device.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A financial transaction medium comprising:
a passive electronic paper display;
a security code displayed on a portion of the passive electronic paper display; and
a payment card identifier to identify the financial transaction medium.

2. The financial transaction medium of claim 1, wherein the security code is updatable each time the financial transaction medium is accessed.

3. The financial transaction medium of claim 1, wherein the security code comprises a dynamic Card Code Verification (CCV) code or a dynamic Personal Identification Number (PIN).

4. The financial transaction medium of claim 1, wherein the security code is embedded in an image.

5. The financial transaction medium of claim 1, wherein the security code is embedded in a Quick Response (QR) code.

6. The financial transaction medium of claim 1, wherein the payment card identifier is displayed on a portion of the passive electronic paper display and is updatable each time the financial transaction medium is accessed.

7. A system comprising:
an imaging device to communicatively couple to a secure server, the imaging device to update a security code displayed on a portion of a passive electronic paper display of a financial transaction medium each time the financial transaction medium is accessed by the imaging device.

8. The system of claim 7, wherein the imaging device comprises a reader to access the financial transaction medium to perform a financial transaction.

9. The system of claim 7, wherein the imaging device comprises an addressable non-contact ion head to write to the passive electronic paper display.

10. The system of claim 7, wherein the financial transaction medium comprises a credit card, gift card, debit card, or prepaid card.

11. A method for updating a financial transaction medium, the method comprising:
writing a security code to a portion of a passive electronic paper display of a financial transaction medium; and
updating the security code written to the passive electronic paper display when the financial transaction medium is accessed.

12. The method of claim 11, wherein updating the security code comprises updating the security code each time the financial transaction medium is accessed by an imaging device for writing to the passive electronic paper display.

13. The method of claim 11, wherein updating the security code comprises updating the security code at a retailer point of sale.

14. The method of claim 11, wherein updating the security code comprises updating the security code via an automated teller machine or a payment card charging unit.

15. The method of claim 11, further comprising:
performing a financial transaction using the security code prior to updating the security code.
